(19) United States
(12) Patent Application Publication
(10) Pub. No.: US 2011/0174985 A1
(43) Pub. Date: Jul. 21, 2011

(54) LITHOGRAPHY SYSTEM WITH LENS ROTATION

(76) Inventor: Jerry Peijster, Maartensdijk (NL)

(21) Appl. No.: 13/010,658

(22) Filed: Jan. 20, 2011

(30) Foreign Application Priority Data
Jan. 21, 2010 (NL) 1037639

(51) Int. Cl. H01J 3/14; H01J 3/22; H01J 3/18

(52) U.S. Cl. 250/400; 250/396 R; 250/396 ML

(57) ABSTRACT

The invention relates to a charged particle based lithography system for projecting an image on a target using a plurality of charged particle beamlets for transferring said image to said target, said system comprising a charged particle column comprising:

an electron optical subassembly comprising a charged particle source, a collimator lens, an aperture array, a blanking means and a beamstop for generating a plurality of charged particle beamlets; and

a projector for projecting said plurality of charged particle beamlets on said target;

said projector being moveably included in the system by means of at least one projector actuator for moving said projector relative to said electron optical subassembly;

said projector actuator being included for mechanically actuating said projector and providing said projector with at least one degree of freedom of movement;

wherein said degree of freedom relates to a movement around an optical axis of the system.

### BACKGROUND OF THE INVENTION

1. Field of the Invention

The present invention relates to a charged particle based lithography system for projecting an image on a target such as a wafer, using a plurality of beamlets for transferring said image to said target, said system comprising a projector for projecting a plurality of beamlets on said target, and at least one actuator for positioning said projected image and said target relative to one another.

2. Description of the Related Art

Such systems are generally known and have the advantage of fabrication on demand and possibly lower tool cost, due to a lack in necessity to use, change and install masks. One example of such a system, disclosed in WO2007/013802, comprises a charged particle column operating in vacuum with a charged particle source including a charged particle extraction means, a means for creating a plurality of parallel beamlets from said extracted charged particles and a plurality of electrostatic lens structures comprising electrodes. The electrostatic lens structures serve amongst other the purpose of focusing and blanking the beamlets. Blanking in this is realized by deflecting one or a multiplicity of such usually focused charged particle beams to prevent the particle beam or multiplicity of beamlets from reaching the target such as a wafer. For realizing the final part of the projection of a computer based image pattern on said target non blanked beamlets are, at a final set of such electrostatic lenses, deflected in a so-called writing direction as part of said imaging process of said target.

During projection, in accordance with the concept of the known system, a target is guided relative to the projection area of said charged particle column, by means of a moveable support, said support moving in a direction other than that of said final projection deflection of the beamlets, commonly transversely thereto. In this process very high accuracy is of prime importance, implying complex and expensive actuation and positioning means. Due to limits in focus depth of the charged particle beams, the small dimensions of the patterns to be written and the thickness variations of the target itself, the positioning of the target is crucial for a successful exposure thereof and should be performed highly precise over a wide range of motion.

Up until now however, target stages have not been a main issue in the development of maskless lithography systems. Therefore, for as far as known in the art, most maskless lithography systems are combined with a stage of relatively simple design, i.e. having the disadvantage of low throughput and/or limited functionality.

A further complication towards successful exposure lies in the fact that while the known charged particle system has means to compensate for errors in the XY-plane of the target using the deflection in the writing direction and the movement of the target holder, it is unable to correct for rotational errors using said deflection and movement of the target holder. Said rotational errors, originating from misalignment around the Z-axis of the projection system and target, in fact from insufficient accuracy in the guidance of the stage in the X- and Y-direction respectively, ultimately result in a position error with this effect being increased when projection takes place further away from the centre of rotation, thereby increasing the accuracy requirements with regard to rotational errors for the target positioning system even further. Said rotational accuracy requirements are typically an order of magnitude higher in comparison with the accuracy requirements in the plane of the target.

With regard to the search for a suitable target positioning system, it is remarked that target positioning systems for use in lithography are generally known, and commonly referred to as wafer stages. The targets to be positioned are generally in the form of wafers. Most if not all practical embodiments of wafer stages however are from the field of conventional lithography, i.e. mask based optical lithography. These known positioning systems, for as far as they can be adapted to maskless lithography, are mostly inappropriate for use in a maskless lithography system at least in the sense of e.g. size, costs and vacuum compatibility. Also, electromagnetic dispersion fields as commonly present at actuators, in particular electromagnetic actuators such as Lorentz motors, are normally undesirable in charged particle projection systems since these electromagnetic fields negatively influence the quality of exposure. When used, electromagnetic actuators invariably necessitate complex magnetic shielding, increasing the complexity and cost of the maskless lithography system.

Where embodiments of positioning systems are disclosed in combination with charged particle exposure systems, they are up to now of a conceptual or relatively expensive nature, suited for prototyping purposes, rather than for large scale manufacture. Practical embodiments of target positioning systems, i.e. wafer stages, generally comprise a steady base frame on which a so called chuck is mounted in such a manner that the chuck can move relative to the base frame in at least one direction. Said chuck supports the target, generally a wafer to be exposed. As the range of motion as compared to the required accuracy is very large, movement is generally realized by dividing the movement in a long stroke for a large range motions, commonly limited to 2 degrees of freedom and a more accurately controlled short stroke with up to 6 degrees of freedom.

Embodiments of known positioning systems also include a so called metrology frame or metro frame for short placed atop the base frame onto which the projection system, for example a charged particle column, is fixated.

Said metro frame typically is of high mass in order to dampen high frequency disturbances, generally in the form of vibrations, and to prevent said disturbances from interfering with the projection system. For the same purpose it is normally mechanically coupled to earth via said base frame, by means of vibration damping, if not eliminating couplers. The metro frame also functions as the reference to which position measurements are taken.

In general, measurement of the position and orientation of the target, e.g. of a wafer on a chuck, in known systems, are taken by highly accurate laser interferometers with regard to the metro frame. The measurement system operates in real time and accurately determines the position of the target along up to 6 axes relative to the metro frame of the lithography system. Further, the position and orientation of the wafer on the wafer positioning system is measured relative to the projection system. Said measurement system, also referred to as metrology system, represents an expensive part of the wafer positioning system in commercially available lithography systems. Actual positioning of said chuck is performed by a control system capable of accurately positioning the chuck based on these measurements using actuators.

One such practically embodied, i.e. industrialized wafer positioning system is known from said field of mask based optical lithography and is represented by patent publication U.S. Pat. No. 5,969,441. This known device is used in an optical lithographic apparatus for holding and positioning multiple targets simultaneously. The system uses two target holders mainly in order to increase manufacturing output, alternatively denoted wafer throughput. Each target is positioned in both the X- and Y-directions. In this system many features are to be duplicated, implying a technically complicated and costly solution. As charged particle beam systems, in general maskless systems, by their nature have a relatively low manufacturing output; this increased complexity brought on by high wafer throughput in optical lithography is not necessary and actually unwanted. Combination of at least this known industrial target stages with modern charged particle beam systems, in particular maskless lithography systems is thus undesired. Another disadvantage of this known system is that it offers no means for adjusting in the Z-direction and is therefore unable to correct errors in the Z-direction, for instance errors due to thickness variations of the target.

WO2004/040614 describes a charged particle projection system for exposing an image onto a wafer. In this known system, charged particle beams are deflected in a direction perpendicular to the scanning direction, i.e. the direction of movement of the target wafer. By adjusting the timing of the deflection perpendicular to the scanning direction, it is possible to correct the positioning of the projected image. However, this timing adjustment only allows for corrections in one direction, effectively having only one degree of freedom. This method is unable to correct for errors in the Z-direction, for instance errors due to thickness variations of the target, and rotations around the Z-axis due to rotational errors.

US2005/0201246 describes a particle-optical projection system intended to compensate for deviations between the image position and the target position with respect to the axial direction, i.e. the Z-direction by measuring the Z-position on several locations on the target, and calculating required lens parameters for the compensation. According to US2005/0201246 such an adjustment may then be achieved by means of electromagnetic lenses, electrostatic lenses or mechanical shifting. In the latter case, the document does not teach how the adjustment in the Z-direction may be achieved. This known approach does not allow for the compensation of rotational errors around the Z-axis, which are technically more challenging to achieve, especially in a multiple beam charged particle system.

Another wafer positioning system is known from U.S. Pat. No. 6,353,271. This publication describes a wafer scanning stage for use in Extreme-Ultraviolet (EUV) lithography. The here disclosed system adjusts both for errors in the Z-direction and rotations around the Z-axis providing a total of 6 degrees of freedom (DOF). The extensive number of control axes in this known system implies a complex 6 DOF measurement system using monolithic mirrors and laser interferometers for measuring and controlling all degrees of freedom. Measurement and control systems of this type are typically costly, increasing the total cost of the lithographic apparatus. A further disadvantage of this known system is that it uses Lorentz motors for actuation implying electromagnetic dispersion fields. Therefore this feature complicates if not prohibits any combination of this known target positioning system with a charged particle beam lithography system as presently at stake.

### SUMMARY OF THE INVENTION

With the above described disadvantages of the known target positioning systems, commonly referred to as stages, it is an object of the present invention to provide for a positioning system that is better, at least reasonably, suited for a maskless lithography system of manufacturers level throughput, economical, and adapted to the nature of present charged particle lithography systems, including the low cost nature and the relatively low throughput requirements thereof. In particular it is an object of the present invention to reduce cost raising accuracy requirements of known wafer stages without sacrificing the accuracy of the system.

In accordance with the present invention the reduction of accuracy requirements of known wafer stages is, in accordance with a basic insight underlying the present invention, realized by performing part of the required positioning actions of the positioning system in the charged particle column of the lithography system. The charged particle column is to this end, and according to the present invention, adapted to include one or more degrees of freedom in the projection lens, so as to achieve such positioning and essentially dividing the positioning in a short stroke part performed by the projection lens and a long stroke part performed by the chuck.

To realize such, the present invention discriminates a projector within the charged particle column. This projector, preferably included as a unit, apart from final projection lenses and beamlet deflector deflecting beamlets for the purpose of deflecting a focused spot over the target, e.g. for “writing a stripe”, includes an aperture array included in the beamlet pathway to the target, before said deflector and lenses.

In the present invention, the metrology frame and the chuck holding the target wafer are preferably positioned such as to remain parallel to one another during the entire projection cycle using multi-DOF actuators in the target positioning system. Additional degrees of freedom in the charged particle column, in the projector in particular, then facilitate adjusting for several types of alignment errors that may occur or that may already be present in the optical column. As the projection lens array performs said adjustments mounted on the stable and accurately positioned metrology frame, the projection lens array is well suited for performing this task.

In order to position the target wafer ultimately parallel to the projection lens the wafer stage components should be made significantly flat as all the components in the stack will contribute to the overall tolerances and flatness of the stage, or the stage would have to be able to correct for errors in the Z, Rx and Ry directions, i.e. rotations in the X- and Y-plane. In the latter case, this means that extra control axes are needed as well as a height-measurement system. In contrast, constructing the stage components as flat as possible allows for a relatively simple setup of the wafer stage needing no height-measurement system but this setup is unable to actively control disturbances in the Z-direction.

Target wafers invariably have thickness variations in the order of hundreds of nanometers, which when uncorrected will result in projection errors. Using the insight that the projection lens array has a relatively large depth of focus it is realized that the lithography system is now adapted to correct for said thickness variations of the target wafer using said one or more degrees of freedom in the projection lens array. Specifically, the Z, Rx and Ry controls ensure that the average plane through the resist-layer is positioned accurately with regard to the projection lens array.

A further advantage of the invention holds that the stroke needed to position the projection lens accurately is significantly smaller compared to the positioning of the chuck with regard to the base frame, as would otherwise be performed in the wafer stage. It has in accordance with yet a further insight been realized that this small stroke of the projection lens allows the use of piezo-actuators rather than Lorentz motors as are known from prior art embodiments. Piezo-actuators have the advantage of not emitting electromagnetic dispersion fields which is highly desirable in charged particle lithography systems, reducing the need for complicated electromagnetic shielding.

By performing the positioning in the plane of the projection lens and the target, i.e. perpendicular to the optical axis, using actuation and positioning of the projector with regard to the metro frame, the long stroke measurement system is significantly simplified. The accuracy requirements on the chuck and wafer stage are thus lowered significantly. The projector now only has to account for the relative small errors of the short stroke enabling the use of a capacitive measurement system of relative simplicity.

The present invention also offers the ability to perform adjustments for alignment errors in the charged particle system. During assembly of a charged particle column, great care has to be taken to correctly align the components comprising the charged particle system correctly with respect to one another. In particular this is necessary for the projector, where several components such as the deflection plates that comprise the electrostatic lens are positioned with relatively high accuracy within 500 nm of their required positions. Other components in the charged particle system that are involved in the final projection of the image on the target are positioned with micrometer accuracy. Given these high accuracy requirements of the charged particle exposure system in general and the projector in particular, this necessary alignment of components is both costly and time consuming. The reduction of alignment requirements as realized by the present invention by being able to compensate for both rotational errors and errors in the Z-direction using one or more degrees of freedom is not only highly desirable in view of advancing technology nodes, but also for use in the current technology node.

A further advantage of performing part of the positioning actions using the projector is to account for rotational errors resulting from the wafer positioning system. This, combined with the previous advantage, reduces the overall requirements on the measurement system of the lithography system with regard to rotational errors, in fact to the same order of magnitude of the other requirements which is highly desirable for manufacturing.

The present invention further recognizes that the masses that have to be moved and positioned in the projector of a charged particle column are much lower as compared to the combined masses of the stage, chuck and wafer, thereby reducing the load on the control system, thus taking advantage of the fact that the mass of the projector is much lower as compared to a wafer positioning system. This is especially true in the case of high frequency motions, i.e. high speed motions. Thus, the present inventions lowering of the moving mass, enables the ability to use higher speed motions, which in turn allows the manufacturing output, i.e. the number of wafers processed per hour, to be increased.

A further insight underlying the present invention is that such inclusion of part of the required positioning can very well be performed simple and cost effective. In the latter respect e.g. a combination of a few of piezo-actuators with spring elements and capacitive sensors may be used for realizing the same. Such actuators, spring elements and sensors are generally known, widely available and not unduly costly.

In an embodiment, the projector is provided with an additional degree of freedom by use of a piezo actuator to adjust the position in the charged particle column by rotating the projector around the optical axis of the projector. By rotating the projector a certain amount around its optical axis, the projected image is rotated virtually the same amount on the target. The ability to rotate is provided by flexible mounts. The piezo-actuators used herein exert forces in one direction only, the use thereof is enabled by the provision of an elastically deformable element, alternatively denoted spring element such as a helical coil spring, to exert a force in a direction opposite to the piezo-actuator. A capacitive sensor is provided for highly accurately measuring the displacement of the projector with regard to the frame of the electron optical column, thus providing position feedback to the control system.

In a yet further elaboration of the present invention, the projector is provided with two additional sets of piezo-actuator, spring elements and capacitive sensors. With the addition of these sets, the projector is provided with 3 degrees of freedom: a rotation around the Z-axis, a translation in the X-direction and a translation in the Y-direction. Now, the 3DOF system according to further elaboration of the present invention is also used to compensate for alignment errors in the entire system.

In accordance with the present invention, an embodiment of the projector further includes three additional piezo-actuators, three additional springs and three additional capacitive sensors.

Using careful arrangement in a triangular layout of said additional piezo-actuators by, the projector now has 6 degrees of freedom, gaining the rotations around the X- and Y-axis and the translation in the Z-direction over the previous embodiment.

In view of the above, according to an aspect, the present invention provides a charged particle based lithography system for projecting an image on a target such as a wafer, using a plurality of charged particle beamlets for transferring said image to said target, said system comprising a charged particle column comprising: an electron optical subassembly comprising a charged particle source, a collimator lens, an aperture array, a blanking means and a beam stop for generating a plurality of charged particle beamlets, and a projector for projecting said plurality of charged particle beamlets on said target to form an image; said projector being moveably included in the system by means of at least one projector actuator for moving said projector relative to said electron optical subassembly, said projector actuator being included for mechanically moving said projector around an optical axis of the system. Thus said projector actuator provides said projector with at least one degree of freedom of movement, wherein said degree of freedom of movement relates to a movement around an optical axis of the system.

In an embodiment said actuator comprises a piezo-element.

In an embodiment said actuator further comprises a spring element included for counteracting a working action of said piezo element.

In an embodiment the projector comprises a projection system comprising an array of charged particle projection lenses, wherein said projection system is carried by a frame.

In an embodiment said projector is supported by means of flexures. In an embodiment said flexures connect the projector to the frame.

In an embodiment said projector is supported by three flexures, the projector actuator being adapted to act in a direction of freedom of movement of one of said flexures.

In an embodiment said actuator is associated with said projector within close vicinity of said one flexure. Preferably, the actuator is adapted to engage said projector or flexure near a connection of the flexure with the projector. In an embodiment the actuator is connected to the projector or flexure.

In an embodiment said system comprises a sensor element for measuring movement of said projector in a direction of movement of said projector actuator.

In an embodiment the sensor-element comprises a capacitive sensor element. In an embodiment the sensor element is embodied as a capacitive sensor element.

In an embodiment the actuator and said spring element are included or arranged in close vicinity to one another, for instance in a configuration wherein they are arranged adjacent to each other.

In an embodiment said spring element and said actuator are included in a configuration wherein they are included on opposite sides of a projector part.

In an embodiment the system comprises three actuators for acting on said projector, wherein said actuators are included in a regular triangular relationship, centered relative to an optical axis of said projector.

In an embodiment the at least one projector actuator is included for acting in a direction along an imaginary plane transverse to an optical axis of said projector.

In an embodiment at least one additional projector actuator is included for acting in a direction substantially parallel to an optical axis of said projector.

In an embodiment the at least one actuator is included for acting in an imaginary plane transverse to an optical axis of the projector, and wherein at least one actuator is included for acting in a direction parallel to said optical axis.

In an embodiment multiple piezo-elements and associated said spring elements are included or arranged in the system in corresponding configurations, preferably regularly arranged centered relative to an optical axis of the projector.

In an embodiment said piezo-elements and associated, spring elements and sensor elements are included or arranged in the system in corresponding configurations. Preferably, each piezo-element and associated spring element included for counteracting a working action of the piezo-element are adapted to provide a different direction of movement of the projector.

In an embodiment the degrees of freedom are provided as a capability of movement in an imaginary plane transverse to an optical axis of the projector, a capability of rotation around an optical axis of the projector, and a capability of tilting around an axis in an imaginary plane transverse to an optical axis of the projector. In an embodiment, the corresponding configurations refer to the relative position of each piezo-element and its associated spring element.

In an embodiment the system comprises a target positioning system for realizing said relative positioning comprising a moveable stage carrying said target, wherein the relative positioning of projected image and target is used to relax accuracy requirements of said target positioning system.

In an embodiment the lithography system further comprises a target positioning system comprising a moveable stage carrying said target, wherein the relative positioning of projector and electron optical subassembly is used to relax accuracy requirements of said target positioning system. In an embodiment, movement of projector relative to the electron optical subassembly causes a change in position of the projection of the image on the target.

In an embodiment the target positioning is solely composed of a long stroke positioning stage.

In an embodiment the projector comprises one of an electrostatic and an electromagnetic lens array for projecting one or more charged particle beamlets.

According to a further aspect the present invention provides a method for projecting an image on a target in a charged particle lithography system, in a charged particle base lithography system as described above, wherein a projector of said system and a surface of a target are maintained substantially parallel with respect to each other throughout the entire projection cycle.

In an embodiment the method comprises the step of moving the projector relative to the system, preferably the electron optical subassembly, to correct for thickness variations in the target wafer.

In an embodiment said thickness variations are compensated for by tilting of the projector around one or more axes in a plane transverse to the optical axis of the projector.

In an embodiment said relative movement of projected image and target serves to adjust for alignment errors in the system.

From either or both the preceding and the following, it may be evident that the presently invented principle may be set into practice in various other manners besides the embodiments described herein, and/or as a combination of two or more embodiments described herein.

### BRIEF DESCRIPTION OF THE DRAWINGS

The invention will, by way of example, be further elucidated in the following embodiments of a charged particle optical system according to the current invention, in which:

FIG. 1 illustrates a schematic representation of the charged particle system including the wafer stage components;

FIG. 2 shows a schematic representation of the electron optical column of a prior art charged particle exposure system;

FIG. 3 schematically illustrates the relative positioning of a projector, a metrology frame, a target and a chuck;

FIG. 4 shows a schematic representation of a projector for a charged particle projection system having means for rotation adjustment according to the present invention;

FIG. 5 shows a representation of a projector having means of rotation and position adjustment according to the present invention;

FIG. 6 illustrates another schematic representation of a further elaboration of the present invention having both a projector with means of rotation and position adjustment according to the present invention,

FIG. 7 shows a side-elevation according to arrows A,A′ in FIG. 6.

In the figures, features having a corresponding structure or function are referred to by identical references.

### DESCRIPTION OF ILLUSTRATIVE EMBODIMENTS

FIG. 1 is a schematic representation of a prior art charged particle system 1 for projecting an image, in particular a control system provided image, onto a target. It includes the wafer stage components to which part of the present invention relates in particular. In this design the charged particle system comprises a control system 2, a vacuum chamber 3 mounted on the base frame 8, which contains the charged particle column 4, the metro frame 6 and the target positioning system 9-13. Said target 9 will generally be a wafer provided with a charged particle sensitive layer in the substrate plane. Target 9 is placed on top of wafer table 10, which is in turn placed on chuck and long stroke drive 13. Measurement system 11 is connected to metrology frame 6 and provides measurements of the relative positioning of wafer table 10 and metro frame 6. The metro frame 6 typically is of relatively high mass and is suspended by vibration isolators 7 for example embodied by spring elements in order to dampen disturbances. The electron optical column 4 performs a final projection using projector 5. The projector 5 comprises a system of either electrostatic or electromagnetic projection lenses. In the preferred embodiment as depicted the lens system comprises an array of electrostatic charged particle lenses. For holding and fixating the entire projector the lens system is included in a carrier frame.

Projector 5 is positioned ultimately close to target 9, i.e. within a range of 25 micron to 75 micron. In accordance with present preference said positioning distance is around, i.e. plus or minus 10%, 50 micron.

To achieve said required accuracy over a large range of motion, the wafer positioning system typically comprises a long stoke component 13 for moving the wafer stage over a relatively large distance in the scanning direction and perpendicular to the scanning direction, and a short stroke component 12 for accurately performing the positioning of the target 9 and for correcting for disturbances. Relative positioning of the wafer stage with regard to the metro frame 6 is measured by measurement system 11. Target 9 is clamped onto the wafer table 10 to ensure the fixation of the target 9 during projection.

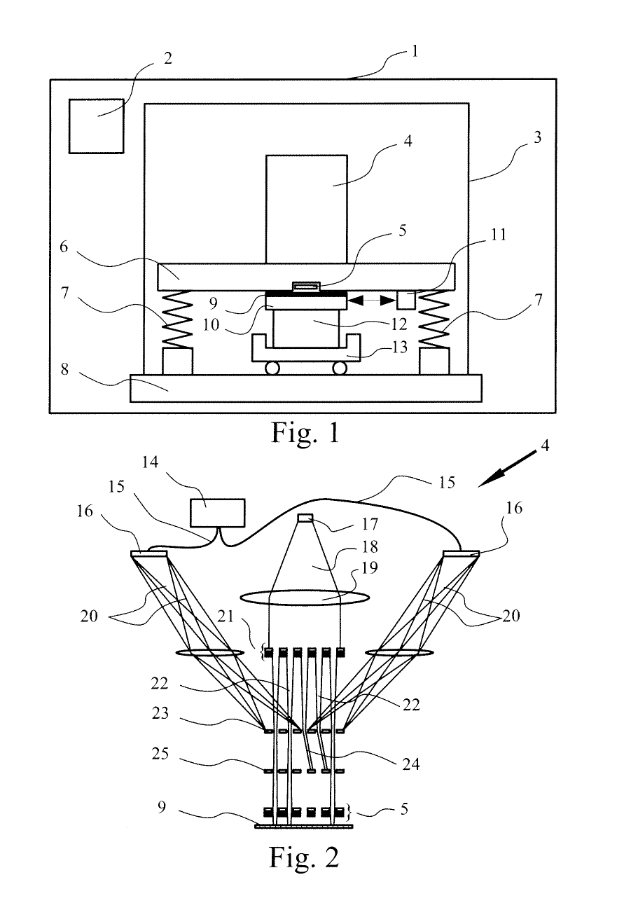

FIG. 2 schematically illustrates an example of a known charged particle column 4 known per se. In the known system a charged particle source 17 generates a charged particle beam 18. The charged particle beams subsequently passes collimator lens 19 for collimating the charged particle beam. Next, the collimated charged particle beam is transformed into a plurality of beamlets 22 by an aperture array 21, comprising in the known system a plate with through-holes, by blocking part of the collimated beam and allowing the beamlets 22 to pass through. The beamlets 22 are projected on blanking means 23 which in this example comprises an array of apertures provided with deflection means. Said blanking means 23 is capable of deflecting individually selected beamlets 24 onto a beamstop 25 formed by an aperture array aligned with the array of apertures of blanker means 23, so as to let through non deflected beamlets. Such deflection of beamlets 24 onto beamstop 25 effectively switches deflected individual beamlets 24 “off”, i.e. off from reaching the target. Non-deflected beamlets are able to pass through uninhibited and are thus not blanked by blanking array 23 and beam stop array 25. Control signals for said blanking array 23 are generated in pattern streamer 14 and sent as electrical signals 15 and converted into optical control signals by modulation means 16. The optical control signals 20 are sent to the blanking array 23 in order to transport the switching instructions. Projector 5 focuses the non-deflected beamlets 22 and deflects the non-deflected beamlets in a writing direction on the target 9 thus realizing a final projection. Said final projection of charged particle beamlets 22 onto the target 9 enables exposure, whilst simultaneously deflecting said beamlets 22 over the target 9 in a first direction, while target 9 is moved in a second direction transversely to said first direction by an above described target positioning system 9-13.

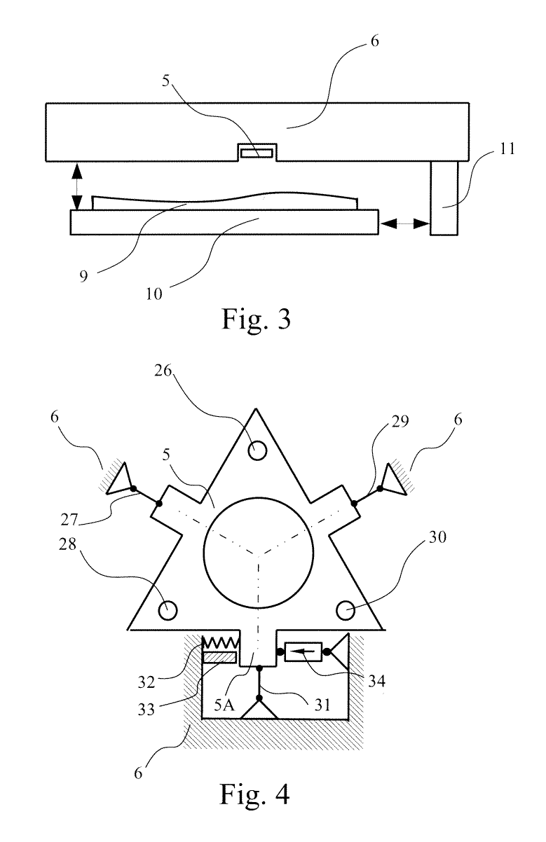

FIG. 3 schematically illustrates the relative positioning of the projector 5, the metrology frame 6, the target 9 and the chuck 10 according to the present invention. The metrology frame 6 and the chuck 10 are positioned such that they remain parallel to one another, in this case by use of 6 DOF actuators for the chuck 10. Projector 5 is according to the present invention provided with 6 DOF actuation means as to able to correct for variations in the target. Position and motion measurement is provided by measurement system 11, in this embodiment using laser interferometers. Alternative systems such as measurement rulers may also be applied.

FIG. 4 schematically illustrates a first embodiment of latter projector 5 according to the present invention. Projector 5 has supports 26, 28 and 30 that are stiff in the Z-direction and positioned in a statically determined arrangement, for example a triangular arrangement as illustrated in the first embodiment, thus fixating the lens in the Z, Rx and Ry directions relative to the metro frame 6. Three other supports 27, 29 and 31, so called “flexible mounts”, in fact elastically deformable designed, fixate projector 5 in the XY plane whilst allowing the lens to rotate around the centre of the lens, i.e. the Z-axis due to their triangular placement around the centre of rotation. In this configuration projector 5 has one degree of freedom, the rotation around the optical (Z) axis Rz.

In the structure according to FIG. 4, capacitive sensor 33 allows for measuring the position of the projector relative to the metro frame. A piezo actuator provides a means for the rotation of the projector. Piezo actuator 34 has a large enough stroke to compensate for the rotational errors, said stroke typically lying in the range of 5×10⁻⁶ to 25×10⁻⁶ m, preferably up to 10×10⁻⁶ m. Capacitive sensor 33 is of high enough accuracy, to accurately measure the position of projector 5 in accordance with present preference typically with an error less than 5×10⁻⁹ m, preferably less than 0.5×10⁹ m. Capacitive sensor 3 in conjunction with control system 2 thus allow for positioning of the projector 5 by measuring and controlling the movement and position of projector 5. In the present example, the piezo actuator only extends in one direction, working against projector part 5A; an elastic spring element 32 is present for providing a counter force to the piezo actuator from another direction on projector part 5A. In this example the counterforce is in a direction opposite to the direction of movement of the piezo actuator. Preferably the projector actuator and elastic spring element are functionally associated within close vicinity of each other, preferably included in close vicinity with the projector and/or sensor element as well, as there is a limited volume budget within the lithography system.

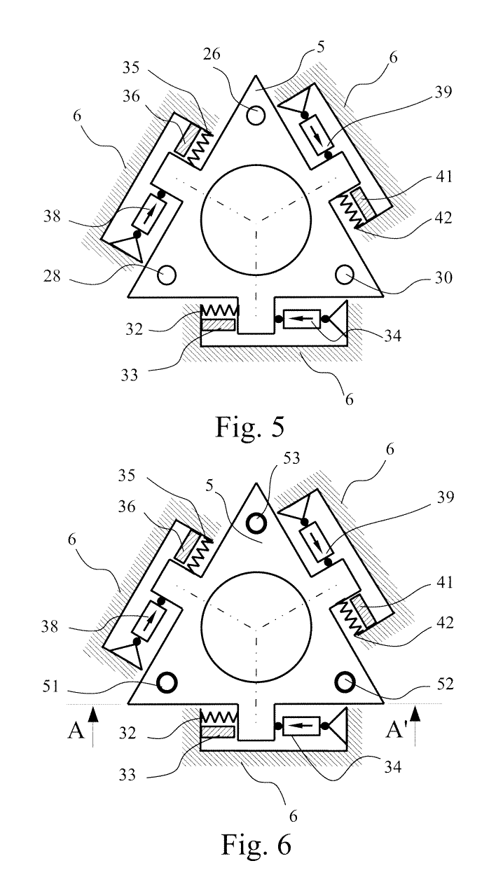

From a top/bottom point of view, FIG. 5 illustrates an enhancement of the previous embodiment where projector 5 also is adjustable in the XY-plane, by the use of two extra piezo actuators 38 and 39. In this embodiment no mounts to fixate projector 5 in the XY-plane are present. The present embodiment allows the three piezo actuators to move the lens in the XY-plane, as well as rotating the lens around the Z-axis. In this configuration projector 5 has 3 degrees of freedom. Additional capacitive sensors 36 and 41 and spring elements 35 and 42 are used to allow for regulating the required motion.

FIG. 6 illustrates a further enhancement where projector 5 is capable of correcting for errors in the Z, Rx and Ry directions. Here besides adjustment options for Rz, X and Y additional adjustments for Z, Rx and Ry are added by use of piezo actuators 51, 52 and 53. In this configuration the projector has 6 degrees of freedom.

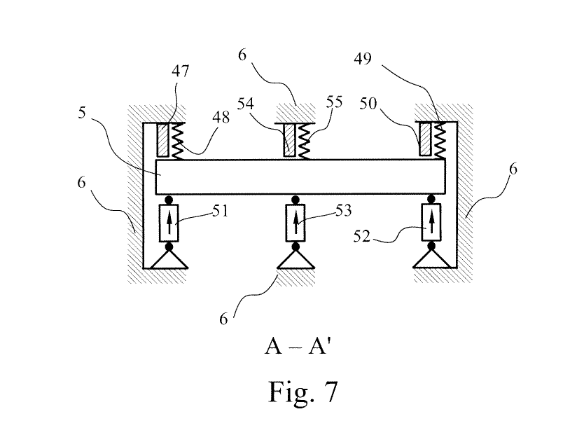

FIG. 7 is a side-elevation according to arrows A,A′ in FIG. 6, illustrating the embodiment of FIG. 6 where projector 5 is capable of correcting for errors in the Z, Rx and Ry directions. Projector 5 is supported in the Z-direction by piezo actuators 51 and 52. Additional capacitive sensors 47 and 50 and spring elements 48 and 49 are present to allow for the required motion in the Z, Rx and Ry directions.

It is to be understood that the above description is included to illustrate the operation of the preferred embodiments and is not meant to limit the scope of the invention. From the above discussion, many variations will be apparent to one skilled in the art that would yet be encompassed by the spirit and scope of the present invention. Apart from the concepts and all pertaining details as described in the preceding, the present invention relates to all features as defined in the following set of claims, as well as to all details in the annexed figures as may directly and unambiguously be derived by one skilled in the art. For as far as reference numbers are included in the claims, these are solely included for indicating an exemplarily meaning, thus not limiting the preceding term, and for that reason included in brackets.

1. A charged particle based lithography system for projecting an image on a target such as a wafer, using a plurality of charged particle beamlets for transferring said image to said target, said system comprising a charged particle column comprising:
an electron optical subassembly comprising a charged particle source, a collimator lens, an aperture array, a blanking means and a beamstop for generating a plurality of charged particle beamlets; and
a projector for projecting said plurality of charged particle beamlets on said target to form an image;
said projector being moveably included in the system by means of at least one projector actuator for moving said projector relative to said electron optical subassembly;
said projector actuator being included for mechanically actuating said projector and providing said projector with at least one degree of freedom of movement;
wherein said degree of freedom relates to a movement around an optical axis of the system.

2. System according to claim 1, wherein said actuator comprises a piezo-element.

3. System according to claim 2, wherein said actuator further comprises a spring element included for counteracting a working action of said piezo element.

4. System according to claim 1, wherein said projector comprises a projection system comprising an array of charged particle projection lenses, said system carried by a frame.

5. System according to claim 1, wherein said projector is supported by means of flexures.

6. System according to claim 5, wherein the projector is supported by three flexures and wherein the projector actuator acts in a direction of freedom of movement of one of said flexures.

7. System according to claim 6, wherein said actuator is associated with said projector within close vicinity of said one flexure.

8. System according to claim 1, wherein said system comprises a sensor element for measuring movement of said projector in a direction of movement of said projector actuator.

9. System according to claim 8, wherein the sensor-element is embodied as a capacitive sensor element.

10. System according to claim 3, wherein the actuator and said spring element are included in close vicinity to one another.

11. System according to claim 3, wherein said spring element and said actuator are included in a configuration wherein they are included on opposite sides of a projector part.

12. System according to claim 1, wherein three actuators for acting on said projector are included in a regular triangular relationship, centered relative to an optical axis of said projector.

13. System according to claim 1, wherein the at least one projector actuator is included for acting in a direction of an imaginary plane transverse to an optical axis of said projector.

14. System according to claim 1, wherein at least one additional projector actuator is included for acting in a direction substantially parallel to an optical axis of said projector.

15. System according to claim 1, wherein the at least one actuator is included for acting in an imaginary plane transverse to an optical axis of the projector, and wherein at least one actuator is included for acting in a direction parallel to said optical axis.

16. System according to claim 12, each of said actuators comprising a piezo-element and being associated with a spring element for counteracting a working action of said piezo element, wherein said piezo-elements and said associated spring elements are included in corresponding configurations.

17. System according to claim 16, said system comprising sensor elements for measuring movement of said projector in a direction of movement of corresponding projector actuators, wherein said piezo-elements, spring elements and sensor elements associated therewith are included in corresponding configurations.

18. The system according to claim 1, wherein the degrees of freedom are realized as a capability of movement in an imaginary plane transverse to an optical axis of the projector, a capability of rotation around an optical axis of the projector, and a capability of tilting around an axis in an imaginary plane transverse to an optical axis of the projector.

19. The system of claim 1, wherein said relative movement of projected image and target serves to adjust for alignment errors in the system.

20. The system of claim 1, comprising a target positioning system for realizing said relative positioning comprising a moveable stage carrying said target, wherein the relative positioning of projected image and target is used to relax accuracy requirements of said target positioning system.

21. The system of claim 20, wherein the target positioning is solely composed of a relatively long stroke positioning stage.

22. The system according to claim 1, wherein the projector comprises one of an electrostatic and an electromagnetic lens array for projecting one or more charged particle beamlets.

23. A method for projecting an image on a target in a charged particle lithography system, in particular according to claim 1, wherein a projector of said system and a surface of a target are maintained substantially parallel with respect to each other throughout the entire projection cycle.

24. The method of claim 23, where the projector corrects for thickness variations in the target wafer.

25. The method according to claim 24, wherein said thickness variations are compensated for by tilting of the projector around one or more axes in a plane transverse to the optical axis of the projector.
